(19) United States
(12) Patent Application Publication
(10) Pub. No.: US 2009/0237003 A1
(43) Pub. Date: Sep. 24, 2009

(54) FEEDBACK CONTROLLED ILLUMINATION SYSTEM HAVING AN ARRAY OF LEDS, AND A DETECTOR AMONG THE LEDS

(75) Inventors: Joseph Ludovicus Antonius Maria Sormani, Eindhoven (NL); Christoph Gerard August Hoelen, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/721,482

(22) PCT Filed: Dec. 9, 2005
(86) PCT No.: PCT/IB2005/054155

§ 371 Date: Jun. 12, 2007

(30) Foreign Application Priority Data
Dec. 16, 2004 (EP) 04106619.2

(51) Int. Cl. H05B 37/02

(52) U.S. Cl. 315/294

(57) ABSTRACT

The present invention relates to an illumination system having an array of differently coloured LEDs, a plurality of collimators, wherein each collimator holds at least one LED, a light mixing element, arranged to mix light generated by the LEDs into a mixed light that is emitted from the illumination system, and a control system for controlling the colour balance of the mixed light. The control system comprises a detector, which is placed among said collimators and encircled by a light shield. The detector detects a fraction of the mixed light that is reflected at an exit window of the mixing element. In this structure the detected light twice passes the mixing element, which provides for a proper mixing of the different colours as well as a proper homogenisation of the light.

### FIELD OF THE INVENTION

The present invention relates to an illumination system comprising an array of different coloured LEDs (Light Emitting Diodes) a plurality of collimators, collimating light from the LEDs, a detector detecting a fraction of the light output of the illumination system, and a control system for controlling the colour balance of the light output.

### BACKGROUND OF THE INVENTION

When designing an illumination system with different coloured LEDs a central question is how to obtain a desired colour balance of light emitted from the illumination system. Due to variations in the output of the LEDs over time even under constant operating conditions, e.g. differential ageing for the different colours and even for LEDs emitting the same colour, variation in the output of the LEDs with variation in operating conditions like drive current and temperature, and variations in the sensitivity of individual LEDs for variation of the operating conditions, and a complex structure of the illumination system, control systems including feedback have been introduced to improve the control. An important part of the control system is a detector for detecting the light output of the illumination system. The detected fraction of the emitted light should be a sample of all LEDs that mirrors the true balance between them in the light output.

A prior art illumination system is disclosed in WO 2002/99333. This prior art illumination system comprises a LED array consisting of LED assemblies arranged in two concentric rings. Each assembly includes a green, blue or red emitting LED and a collimator lens arranged in front of the LED. The illumination system further comprises a detector arranged at the central axis of the rings, a condenser lens that directs the light output from the LED array onto a target light guide, and a partially reflecting element. The partially reflecting element is arranged between the condenser lens and the light guide for reflecting and focusing a fraction of the light from all the LEDs onto the detector. While this illumination system works well there is still room for improvements.

In order to achieve a true detection, it is desired to detect equal parts of the light emitted by each LED. The collimator and condenser lenses and the partially reflecting element all have as substantial functions to direct and focus the emitted light from all the LEDs. Due to a number of reflections involved a level of homogenisation of the light is obtained. An additional homogenisation is performed by means of a diffuser arranged just in front of the detector. However, it still is likely that the detected light is not optimally homogenised. Further, it is undesirable to position a partially reflecting element in the path of the light output both as regards the complexity of the illumination system structure and as regards the additional loss, in the intensity of the light emitted from the illumination system, that is introduced by the reflective element.

### SUMMARY OF THE INVENTION

It is an object of the present invention to provide an illumination system that eliminates the above-mentioned drawbacks of the prior art illumination system.

This object is achieved by an illumination system according to the present invention as claimed in claim 1.

Thus, in accordance with one aspect thereof, the invention relates to an illumination system comprising an array of differently coloured LEDs and a plurality of collimators. Each collimator holds at least one LED. The illumination system further comprises a light mixing element, arranged to mix light generated by the LEDs into a mixed light that is emitted from the illumination system, and a control system for controlling the colour balance of the mixed light. The colour mixing element has an entrance window, through which the light generated by the LEDs is received, and an exit window, through which the mixed light is emitted. The control system comprises a detector, which is placed among said collimators and encircled by a light shield, such that the detector detects a fraction of the mixed light that is reflected at the exit window and does not affect the light emitted from the individual collimators containing the LEDs.

This invention advantageously uses the reflection, also called Fresnel reflection, at the exit window of the mixing element, that is due to the light crossing a boundary of different refraction indices.

Thus, the reflected light rays are detected by the detector. Since this reflection occurs in any case, and since there is no additional reflective element the losses are minimised.

Additionally, the use of a light mixing element in combination with the collimators where the light emitted by the LEDs that reaches the detector has travelled at least twice through the total length thereof, is advantageous. Thereby there is provided optimal conditions for sensing the light from the various LEDs with equal weight factors, while at the same time minimizing the overall dimensions of the system. Thus, the detected light is a best possible sample of the light actually emitted by the LEDs.

As an additional advantage, since the detector is arranged within a light shield, it is shielded from any stray light that originates directly from neighbouring LEDs.

In accordance with an embodiment of the illumination system of this invention, as defined in claim 2, several detectors are arranged each within a respective light shield. Ideally the reflected light that reaches the LED/detector area is absolutely homogeneous, while in practise there might be minor variations. This embodiment has the advantage of collecting a larger part of the reflected fraction, which increases the precision of the control even more.

In another embodiment of the illumination system according to the invention, as defined in claim 3, at least two detectors placed within a single light shield have different sensitivities, e.g. different spectral responses. In this way, a measure of the amount of light from the individual LEDs, each with its own colour, can be measured, without switching LEDs off and on.

In another embodiment of the illumination system according to the invention, as defined in claim 4, the light shield or at least one of the plurality of light shields is a light concentrator, also called collimator, though primarily when used for guiding the light in the opposite direction. Thus, in case the light concentrator is similar to, the collimators used for the light emitters, the production of the illumination system may be simplified, and favourable configurations of light emitters and light sensors can be obtained. In particular this is true if all collimators are the same or are integrally formed.

In accordance with an embodiment of the illumination system of this invention, as defined in claim 5, the different colours of the detected light are separated in an easy way by means of colour filters.

In an embodiment of the illumination system according to the invention, as defined in claim 6, the round cross sectional shape provides for an optimal collimation of the light emitted by the LED.

In an embodiment of the illumination system according to the invention, as defined in claim 7, an efficient packing of the collimators, and a sufficient collimation is obtained. At the same time the polygonal shape provides for a first homogenisation of the light emitted from the collimator. Preferably, the polygonal shape is one of a square or a hexagonal cross sectional shape.

In an embodiment of the illumination system according to the invention, as defined in claim 8, the homogenisation of the light emitted from the collimator is further enhanced. The cross sectional shape of the segments in a plane perpendicular to the optical axis can either be continuous (e.g. circular or elliptical) or polygonal.

These and other aspects of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 is a schematic longitudinally sectional view of an embodiment of an illumination system according to the present invention;

FIG. 2 is a schematic perspective view of the illumination system in FIG. 1;

FIGS. 3, 4, 6, and 7 are schematic sectional views of a respective part of further embodiments of the illumination system; and

FIG. 5 is a fractional, perspective view of another embodiment of the illumination system.

### DESCRIPTION OF PREFERRED EMBODIMENTS

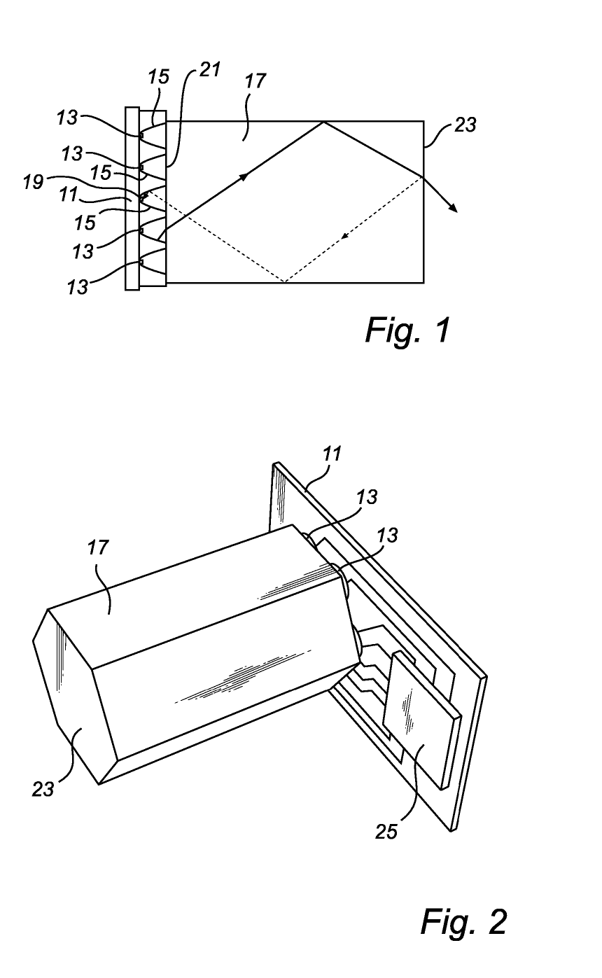

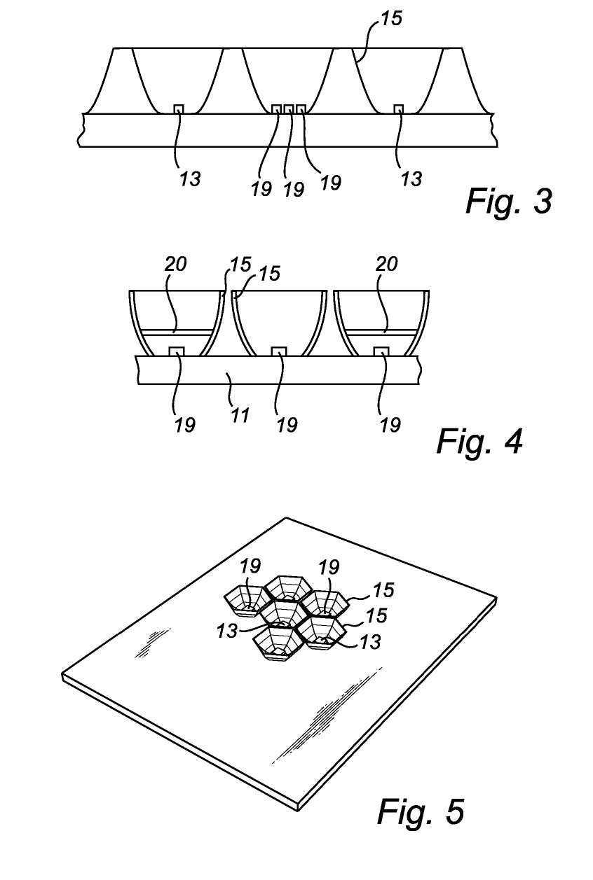

As shown in FIG. 1, one embodiment of the illumination system comprises a PCB (Printed Circuit Board) 11, an array of LEDs 13, where the LEDs 13 are positioned symmetrically on the PCB 11, a plurality of collimators 15, a light mixing element 17, and a detector 19, which is arranged within a light shield 15. The light shield shields the detector 19 from direct light from neighbouring LEDs 13 while admitting light that has been reflected internally of the mixing element 17 as will be further explained below. Each LED 13 is arranged in, and thus encircled by, a separate one of the collimators 15. Thus, one collimator 15 is provided for each LED 13. However, there is one more collimator 15, which is used as the light shield for the detector 19. In principle, the detector can be placed in any one of the collimators 15 without consequences for the correct functioning. However, to obtain the shortest possible light mixing element 17 it is advantageous to distribute the various LEDs 13 throughout the source area containing the LEDs. Then various colours are generated at positions spread concentrically around the optical axis of the system. It may be advantageous then to mount a detector on the optical axis to maintain optimal symmetry.

The mixing element, or mixing rod, 17 is hexagonal in cross section. Similarly, the LEDs 13 are positioned such that the periphery of the LED array makes a hexagon.

Other mixing rod shapes that work well are: triangular and rectangular (including square). Spatial mixing of the light is enhanced, and as a result, at the exit window of the light mixing rod, the light is spatially homogenized. In general polygonal shapes are preferable, while circular, elliptical, etc. shapes do not mix well or mix poorly. However also some polygonal shapes like five-sided mix less good. In general, when a surface can be covered with the chosen shape without overlap or without holes, the shape will mix.

To obtain configurations that result in optimal detection and/or minimum dimensions of the system, or to maximize the average flux density or brightness of the luminous output of the system while at the same time minimizing the overall dimensions, the shape and size of the collimators 15 may vary with position. As an example, a collimator with small diameter may be used for a detector, located between collimators with larger diameters containing LEDs. This is possible because the angular distribution of the light reaching the detector is not of primary interest, while the detector still is shielded effectively from the LEDs and only detects well mixed light. Also, for certain mixing rod cross sectional shapes it may be advantageous to vary shape and/or size of the collimators with position to obtain an optimal spatial ordering. In this description, when a similar type of element is used for both the LED collimators and for the light shield the word collimator is used also in the cases where a detector is put inside, although in that case it is not used as a collimator but as a concentrator.

Preferably, the detector 19 is arranged at the central axis of the mixing rod 17, i.e. at the centre of the LED array. The detector 19 is a part of a control system, also comprising programmable control circuitry 25.

When light is emitted from the LEDs 13 it is gathered and directed towards the mixing rod 17 by means of the collimators 15. This LED output light then enters the mixing rod 17 through an entrance window 21 thereof, which in this embodiment is a first planar end surface of the mixing rod 17. The collimators 15 have a light entrance window facing, or comprising, the LEDs 13, a light output window facing the light mixing rod 17, and a light reflecting side surface. The collimators are filled with air. Alternatively, the collimators are filled with a dielectric that may be optically coupled to the light mixing section. Alternatively, the collimators 15 and the light mixing rod 17 are made of the same material and form a single integral component. A majority of the light passes through the mixing rod 17, while being mixed, as regards the different coloured light beams from different LEDs 13, and exits through an exit window 23 thereof as mixed light. The exit window 23 is a second planar end surface 23 of the mixing rod, which second end surface is parallel with the first end surface 21. In an alternative embodiment, the second end surface 23 of the light mixing rod has a convex shape. The end surface of the light mixing rod may be provided with a surface texture such that a beam shaping or light diffusing structure, a micro lens array, or light scattering particles to further homogenize the light beam by eliminating or reducing the relation between the individual light source positions and the spatio-angular distribution of the light emitted by the illumination system. Alternatively, the beam shaper or diffuser is applied as a separate component to obtain the enhanced homogenisation. The mixed light thus emitted from the illumination system is provided to some target, such as a light guide. However, a small fraction, for example a few percent, of the mixed light is reflected at the exit window 23 and returns, either straightly or by total reflections against the walls of the mixing rod 17, towards the entrance end 21. A part of the reflected light enters the very collimator 15 in which the detector 19 is mounted. An exemplifying light ray from one of the LEDs 13 and a reflected fraction thereof are shown in FIG. 1 as a solid line and a dashed line respectively. The length of the mixing rod 17 is optimised in order to obtain a uniform colour mix throughout the beam of light emitted from the illumination system 11. Since the detected light originates from the exit window of the mixing rod 17, the colour balance of the detected light is even better than that of the emitted light, because now the double length of the mixing rod has been used. Thus, a high quality actual value for the feedback control is obtained that optimally represents the average luminous characteristics of the light beam emitted by the illumination system.

The read-out of the optical detector (or detectors) is preferably synchronized with the driving of the LEDs. This enables the use of a single optical detector to independently measure the contributions of the various colours to the mixed light beam.

Above, preferred embodiments of the illumination system according to the present invention have been described. These should be seen as merely non-limiting examples. As understood by a skilled person, many modifications and alternative embodiments are possible within the scope of the invention.

In an alternative embodiment several detectors are arranged in one and the same collimator. In an alternative embodiment several detectors are arranged, though each in a separate collimator.

In an alternative embodiment at least two collimators contain at least one detector, and one of the collimators contains at least two detectors.

In an alternative embodiment of the illumination system according to the invention, a light diffusing element is mounted in the collimator(s) containing the detector(s), preferably near the entrance window of the light mixing rod, to further homogenize the light before it reaches the detector(s), thereby further eliminating the relation between the LED position(s) and the signal generated by the light detector(s).

In an alternative embodiment of the illumination system according to the invention several detectors are used. The detectors 19 are provided each with a colour filter 20 filtering out a single colour, as schematically shown in FIG. 4. Application of different colour filters enables discrimination between the light emitted by the LEDs that generate light at different wavelengths without the need of temporally resolved light detection in synchronization with modulated driving of the LEDs. As an example, a detector with a red transmitting colour filter, a detector with a green transmitting colour filter and a detector with a blue transmitting colour filter can be used to monitor the light emitted by red, green and blue LEDs simultaneously, or without synchronization with the driving of the LEDs. As another example, one detector with an appropriate filter can be used to monitor the light of the specific colour, while another detector might be used to measure the total flux generated. As an alternative, or in addition to, the separate filter elements arranged in front of the detectors, electronic filters processing the output signals of the detectors are used.

In an alternative embodiment as shown most schematically in FIG. 5, the collimators are hexagonal in shape. Other polygonal shapes are also possible.

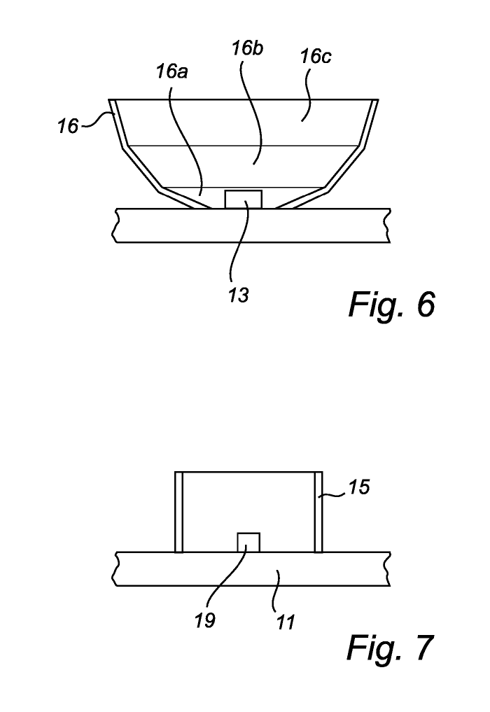

In an alternative embodiment as shown most schematically in FIG. 6, the collimator wall 16 is segmented such that concentric portions 16a-16c positioned on top of each other have transitions in the form of bends between them. Thus, the inner surface of the wall 16 is segmented in a cross section in a plane through the optical axis of the collimator.

In an alternative embodiment the control system further comprises a temperature sensor to enable correction for temperature induced deviations of the luminous output of the system, or to set a requested colour point of the emitted light via a feed forward control loop. Preferably, this sensor is located near the LEDs. Alternatively or additionally, the temperature sensor output may be used to limit the system power and the resulting system temperature.

In an alternative embodiment according to the invention, a temperature sensor is applied together with one or more light detectors.

In an alternative embodiment according to the invention the illumination system includes synchronized light modulating drivers for at least two of the colours of light emitted by the LEDs. The detector operates synchronized and the detection of mixed light is temporally resolved.

In an alternative embodiment the light shield is a light guiding tube 15 of constant diameter, as schematically shown in FIG. 7. It should be noted, though, that the use of a collimator as light shield is preferred.

The detector or detectors may comprise a photodiode with a relatively flat spectral response (or sensitivity), a photodiode with a colour filter such as a high pass filter, a low pass filter or a band pass filter, or combinations thereof. Yet another alternative is to use a photosensor array.

Thus, as explained by means of the embodiments above, a low loss structure and a detected light having a high quality, to be used for feedback control purposes, are provided.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. An illumination system comprising an array of differently coloured LEDs, a plurality of collimators, wherein each collimator holds at least one LED, a light mixing element, arranged to mix light generated by the LEDs into a mixed light that is emitted from the illumination system, wherein the light mixing element has an entrance window, through which the light generated by the LEDs is received, and an exit window, through which the mixed light is emitted, and a control system for controlling the colour balance of the mixed light, wherein the control system comprises a detector, which is placed among said collimators and encircled by a light shield, such that the detector detects a fraction of the mixed light that is reflected at the exit window.

2. An illumination system according to claim 1, wherein the control system comprises a plurality of detectors, each one thereof being placed among said collimators and being encircled by a respective light shield.

3. An illumination system according to claim 1, wherein the control system comprises at least two detectors having different sensitivities and being encircled by one and the same light shield.

4. An illumination system according to claim 1, wherein at least one light shield is a light concentrator.

5. An illumination system according to claim 1, wherein the control system comprises a plurality of detectors of which at least one is provided with a colour filter, for enabling separate control of each colour.

6. An illumination system according to claim 1, wherein at least one of said collimators has a round cross sectional shape in a plane perpendicular to a central axis of the colour mixing element.

7. An illumination system according to claim 1, wherein at least one of said collimators has a polygonal cross sectional shape in a plane perpendicular to a central axis of the colour mixing element.

8. An illumination system according to claim 1, wherein at least one of said collimators has an outer wall that is segmented in concentric portions.

9. An illumination system according to claim 1 further comprising synchronized light modulating drivers for at least two of the colours of light emitted by the LEDs, wherein said detector is arranged for synchronized temporally resolved detection of said mixed light.

10. An illumination system according to claim 1, wherein said control system comprises a temperature sensor.
